(19) United States
(12) Patent Application Publication
(10) Pub. No.: US 2014/0030564 A1
(43) Pub. Date: Jan. 30, 2014

(54) RECHARGEABLE BATTERY

(71) Applicant: SAMSUNG SDI CO., LTD., Yongin-si (KR)

(72) Inventor: Bora LEE, Yongin-si (KR)

(73) Assignee: SAMSUNG SDI CO., LTD., Yongin-si (KR)

(21) Appl. No.: 13/680,305

(22) Filed: Nov. 19, 2012

(30) Foreign Application Priority Data
Jul. 24, 2012 (KR) 10-2012-0080686

(51) Int. Cl. H01M 2/12

(52) U.S. Cl. CPC H01M 2/12
USPC 429/82

(57) ABSTRACT

A rechargeable battery, which can improve safety by rapidly releasing internal gases by forming a vent in a pouch. The rechargeable battery includes an electrode assembly including a first electrode, a second electrode and a separator interposed between the first electrode and the second electrode, a pouch accommodating the electrode assembly and including a metal layer, and a vent formed on at least one side of the pouch, wherein the vent is formed by forming a trench in the metal layer.

### CLAIM OF PRIORITY

This application makes reference to, incorporates the same herein, and claims all benefits accruing under 35 U.S.C. §119 from an application earlier filed in the Korean Intellectual Property Office on the 24 of Jul. 2012 and there duly assigned Serial No. 10-2012-0080686.

### BACKGROUND OF THE INVENTION

1. Field of the Invention

Embodiments of the present invention generally relate to a rechargeable battery.

2. Description of the Related Art

In a rechargeable battery, the internal temperature of the battery rises and gases are generated due to an abnormal operation of battery, such as battery short or an overcharge, the internal pressure of the battery rises above a predetermined level. When a nickel-hydrogen (NiH) battery, for example, is overcharged, OH— group in an electrolyte is decomposed to generate oxygen gases, so that the internal pressure of the battery may increase. In addition, when a lithium secondary battery using a lithium metal or carbon as a negative active material is overcharged or overdischarged, heat is generated to facilitate decomposition of an organic solvent and gases are generated, so that the internal pressure of the battery may rise. Further, since the gases are flammable, there is a danger of fire or short circuit.

The above information disclosed in this Related Art section is only for enhancement of understanding of the background of the invention and therefore it may contain information that does not form the prior art that is already known to a person of ordinary skill in the art.

### SUMMARY OF THE INVENTION

Embodiments of the present invention provide a rechargeable battery, which can improve safety by rapidly releasing internal gases by forming a vent in a pouch.

According to an embodiment of the present invention, a rechargeable battery is provided, the rechargeable battery including an electrode assembly including a first electrode, a second electrode and a separator interposed between the first electrode and the second electrode, a pouch accommodating the electrode assembly and including a metal layer, and a vent formed on at least one side of the pouch, wherein the vent may be formed by forming a trench in the metal layer.

In addition, the pouch may further include a first pouch layer formed on one surface of the metal layer facing the electrode assembly, and a second pouch layer formed on the other surface of the metal layer.

The vent may be formed by forming a trench on one surface of the metal layer contacting the first pouch layer.

In addition, the vent may be formed by forming a trench on the other surface of the metal layer contacting the first pouch layer.

The first pouch layer may be made of an insulating, thermally adhesive material.

The second pouch layer may be made of at least one of nylon, polyethylene terephthalate (PET), polybutylene terephthalate (PBT) and polybutylene naphthalate (PBN).

The rechargeable battery may further include electrode tabs electrically connected to the first electrode and the second electrode and protruding to the other side of the pouch, wherein the pouch has a pair of facing long sides and a pair of facing short sides connecting the long sides, the electrode tabs protrude one of the short sides, and the vent may be formed to be close to the short side facing the short side from which the electrode tabs protrude.

The vent may be shaped of a diagonal line extending from the long side to the short side of the pouch.

In addition, the vent may be shaped of an arc extending from the long side to the short side of the pouch.

In addition, the vent may be shaped of a diagonal line extending toward an interconnection point where the long side and the short side of the pouch meet.

The vent may include a main vent portion shaped of a diagonal line extending from the long side to the short side of the pouch, and auxiliary vent portions extending from opposite ends of the main vent portion and formed to be parallel with the long and short sides of the pouch.

The vent may be formed at one corner of the pouch.

Alternatively, the vent may be formed at both corners of the pouch.

The pouch may include a first pouch film having an accommodation groove in which the electrode assembly may be accommodated and a second pouch film covering the accommodation groove and coupled to the first pouch film, and the vent may be formed in the accommodation groove of the first pouch film.

In addition, the pouch may have a pair of facing long sides and a pair of facing short sides connecting the long sides, the first pouch film and the second pouch film may be connected to each other through one of the pair of short sides, and the vent may be formed to be close to the one short side.

A sealing portion may be formed on the outer periphery of the accommodation groove of the first pouch film to be sealed to the second pouch film.

The rechargeable battery may further include electrode tabs electrically connected to the first electrode and the second electrode and protruding to one side of the pouch, and each of the electrode tabs includes an insulation member formed at contact portions between the electrode tabs and the sealing portion.

As described above, in the rechargeable battery according to an embodiment of the present invention, a vent may be formed at one side of a pouch, thereby rapidly releasing the gases generated due to an abnormal operation of an electrode assembly to the outside. Accordingly, the rechargeable battery according to an embodiment of the present invention can prevent short circuit or fire of the electrode assembly, thereby improving the safety of the rechargeable battery.

Additional aspects and/or advantages of the invention will be set forth in part in the description which follows and, in part, will be obvious from the description, or may be learned by practice of the invention.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a perspective view of a rechargeable battery according to an embodiment of the present invention;

FIG. 2 is a front view of the rechargeable battery shown in FIG. 1;

FIG. 3 is a cross-sectional view taken along the line I-I′ shown in FIG. 2;

FIG. 4 is a cross-sectional view of a rechargeable battery according to another embodiment of the present invention;

FIG. 5 is a front view of the rechargeable battery shown in FIG. 4;

FIG. 6 is a front view of a rechargeable battery according to still another embodiment of the present invention;

FIG. 7 is a front view of a rechargeable battery according to still another embodiment of the present invention; and

FIG. 8 is a front view of a rechargeable battery according to still another embodiment of the present invention.

### DETAILED DESCRIPTION OF THE INVENTION

The example embodiments are described more fully hereinafter with reference to the accompanying drawings. The inventive concept may, however, be embodied in many different forms and should not be construed as limited to the example embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like or similar reference numerals refer to like or similar elements throughout. As used herein, the term “and/or” includes any and all combinations of one or more of the associated listed items.

It will be understood that, although the terms first, second, third etc. may be used herein to describe various elements, components, regions, layers, patterns and/or sections, these elements, components, regions, layers, patterns and/or sections should not be limited by these terms. These terms are only used to distinguish one element, component, region, layer pattern or section from another region, layer, pattern or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross sectional illustrations that are schematic illustrations of illustratively idealized example embodiments (and intermediate structures) of the inventive concept. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the accompanying drawings.

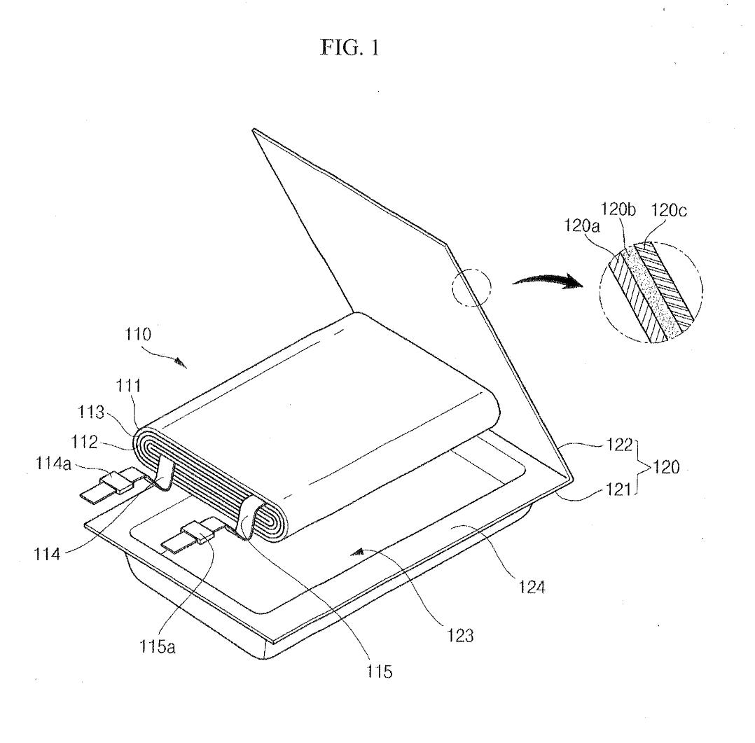

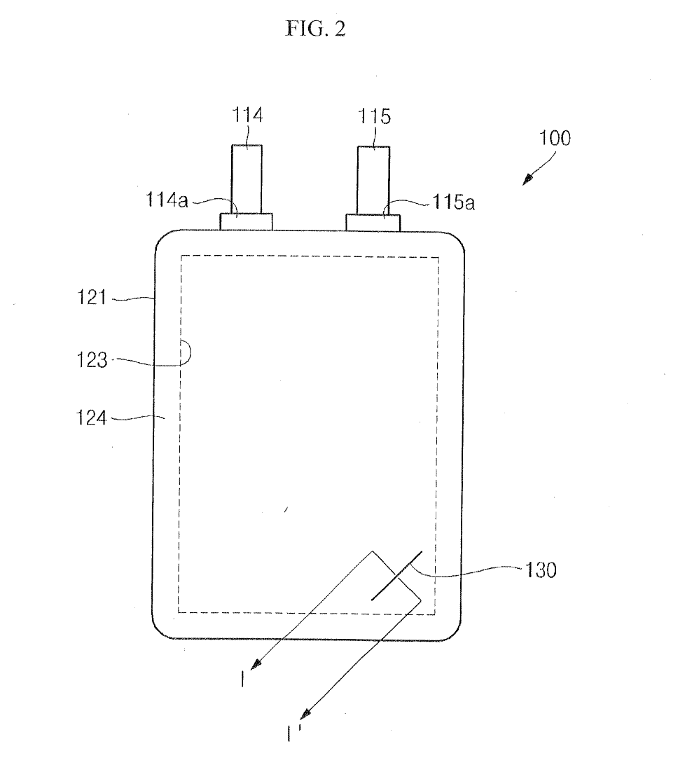

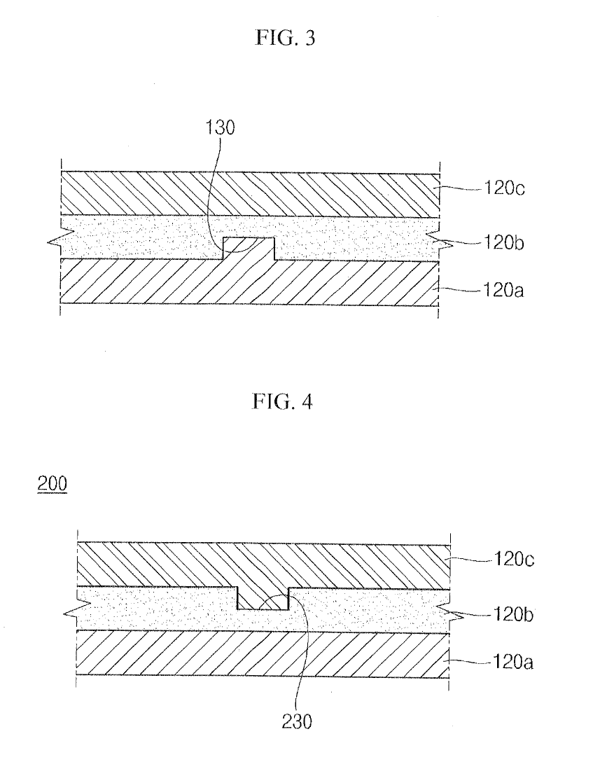

FIG. 1 is a perspective view of a rechargeable battery according to an embodiment of the present invention, FIG. 2 is a front view of the rechargeable battery shown in FIG. 1, and FIG. 3 is a cross-sectional view taken along the line I-I′ shown in FIG. 2.

Referring to FIGS. 1 to 3, the rechargeable battery 100 according to an embodiment of the present invention includes an electrode assembly 110, a pouch 120 and a vent 130.

The electrode assembly 110 includes a first electrode 111 a second electrode 112 and a separator 113 interposed between the first electrode 111 and the second electrode 112. The electrode assembly 110 may be formed by winding a stacked structure of the first electrode 111, the separator 113 and the second electrode 112. Here, the first electrode 111 may function as a positive electrode and the second electrode 112 may function as a negative electrode, and vice versa. The following description will be made on the assumption that the first electrode 111 is a positive electrode and the second electrode 112 is a negative electrode.

The first electrode 111 includes a first electrode active material layer coated on both surfaces of a first electrode current collector made of a highly conductive metal thin plate, for example, an aluminum (Al) foil. A chalcogenide compound may be used as the first electrode active material, and examples thereof may include composite metal oxides, such as LiCoO₂, LiMn₂O₄, LiNiO₂, or LiNiMnO₂. A first electrode tab 114 may be formed at a first electrode uncoated portion of the first electrode current collector where the first electrode active material layer is not formed. That is to say, one end of the first electrode tab 114 may be electrically connected to the first electrode uncoated portion and the other end thereof protrudes to the outside. In addition, an insulation member 114a may be attached to the first electrode tab 114 to prevent the first electrode tab 114 from being short-circuited to the pouch 120.

The second electrode 112 includes a second electrode active material layer coated on both surfaces of a second electrode current collector made of a conductive metal thin plate, for example, a copper (Cu) or nickel (Ni) foil. A carbon-based material, silicon (Si), tin (Sn), tin oxide, tin alloy composite, transition metal oxide, lithium metal nitride, or metal oxide may be used as the second electrode active material. A second electrode tab 115 may be formed at a second electrode uncoated portion of the second electrode current collector where the second electrode active material layer is not formed. That is to say, one end of the second electrode tab 115 may be electrically connected to the second electrode uncoated portion and the other end thereof protrudes to the outside. In addition, an insulation member 115a may be attached to the second electrode tab 115 to prevent the second electrode tab 115 from being short-circuited to the pouch 120.

The insulation members 114a and 115a formed at the first and second electrode tabs 114 and 115 may prevent short circuits between the first and second electrode tabs 114 and 115, the first and second electrode tabs 114 and 115, and the first and second electrodes 111 and 112 having different polarities, and may prevent short circuits between the pouch 120 and the first and second electrode tabs 114 and 115 when sealing the pouch 120 after accommodating the electrode assembly 110 in the pouch 120. Accordingly, the insulation members 114a and 115a are preferably made of a material having an insulating property to be capable of preventing short circuits and having resistance against an electrolyte. For example, the insulation members 114a and 115a may be formed of insulating tapes including polyphenylene sulfide (PS), polymide (PI) or polypropylene (PP).

The separator 113 may be interposed between the first electrode 111 and the second electrode 112 and prevents a short circuit between the first electrode 111 and the second electrode 112. The separator 113 may be made of one selected from the group consisting of polyethylene, polypropylene, and a copolymer of polyethylene and polypropylene. In order to prevent the short circuit between the first electrode 111 and the second electrode 112, the separator 113 may be formed to have a width greater than that of the first electrode 111 or the second electrode 112.

The pouch 120 accommodates the electrode assembly 110 and may be formed by sealing the outer periphery of the electrode assembly 110. The pouch 120 includes a first pouch film 121 in which the electrode assembly 110 is accommodated, and a second pouch film 122 coupled to the first pouch film 121. That is to say, the pouch 120 may be formed by bending the center of one side of an integrally formed rectangular pouch film, thereby forming the first pouch film 121 and the second pouch film 122. An accommodation groove 123 in which the electrode assembly 110 can be accommodated may be formed in the first pouch film 121 by pressing, and a sealing portion 124 may be formed on the outer periphery of the accommodation groove 123 of the first pouch film 121 to be sealed with the second pouch film 122. The sealing portion 124 may be formed along one side in which the first pouch film 121 and the second pouch film 122 are integrally brought into contact with each other and along the other three sides. The pouch 120 has a pair of facing long sides on which the first pouch film 121 and the second pouch film 122 face each other, and a pair of facing short sides perpendicular to the long sides. Here, the first and second electrode tabs 114 and 115 are drawn through one of the short sides, the one facing the short side to which the first pouch film 121 and the second pouch film 122 are connected. Here, the insulation members 114a and 115a formed in the first and second electrode tabs 114 and 115 are sealed to the sealing portion 124. That is to say, the insulation members 114a and 115a are formed at contact portions of the first and second electrode tabs 114 and 115 and the sealing portion 124 and prevent the first and second electrode tabs 114 and 115 from being short-circuited to the pouch 120.

The pouch 120 may be formed to have a multi-layered structure having a first pouch layer 120a, a metal layer 120b and a second pouch layer 120c.

The first pouch layer 120a may be an interior surface of the pouch 120 and may be made of an insulating, thermally adhesive material. In addition, the first pouch layer 120a may be formed on one surface of the metal layer 120b, forming the interior surface of the pouch 120 facing the electrode assembly 110. The first pouch layer 120a may be made of casted polypropylene (CPP) and equivalents thereof, which do not react with an electrolyte. If the electrode assembly 110 may be accommodated in the first pouch film 121 and then covered by the second pouch film 122, the first pouch layers 120a of the first pouch film 121 and the second pouch film 122 come into contact with each other. Therefore, if the sealing portion 124 may be thermally fused, the first pouch layers 120a of the first pouch film 121 and the second pouch film 122 are adhered to each other, thereby sealing the pouch 120.

The metal layer 120b, which may be interposed between the first pouch layer 120a and the second pouch layer 120c, prevents external moisture and oxygen from being induced into the pouch 120 and prevents an electrolyte contained in the pouch 120 from being leaked to the outside of the pouch 120. In addition, the metal layer 120b serves to maintain mechanical strength of the pouch 120. The metal layer 120b may be generally made of aluminum. In addition, the metal layer 120b includes a vent 130 formed therein, which will later be described.

The second pouch layer 120c may be an exterior surface of the pouch 120 and reduces mechanical, chemical impacts with respect to external electronic device. In addition, the second pouch layer 120c may be formed on the other surface of the metal layer 120b, forming the exterior surface of the pouch 120. The second pouch layer 120c may be made of nylon, polyethylene terephthalate (PET), polybutylene terephthalate (PBT), polybutylene naphthalate (PBN) or equivalents thereof.

The vent 130 may be formed in the pouch 120. In addition, the vent 130 may be ruptured when internal gas is generated in the pouch 120 due to an abnormal operation of the electrode assembly 110, thereby releasing the gas to the outside. The vent 130 may be formed in the accommodation groove 123 of the first pouch film 121 in the pouch 120. The vent 130 may also be formed in the second pouch film 122. However, when the internal gas is generated in the pouch 120 due to the abnormal operation of the electrode assembly 110, the accommodation groove 123 of the first pouch film 121 accommodating the electrode assembly 110 more easily swells. Thus, the vent 130 may be preferably formed in the accommodation groove 123 of the first pouch film 121. In addition, the vent 130 may be formed in both of the first pouch film 121 and the second pouch film 122.

Further, the vent 130 may be formed to be closer to the short side facing the short side from which the first and second electrode tabs 114 and 115 are drawn. In other words, the vent 130 may be formed to be far from the first and second electrode tabs 114 and 115. The vent 130 may be formed at one corner of the pouch 120 and may be shaped of a diagonal line extending from the long side to the short side of the pouch 120. In general, when the internal gas is generated in a pouch due to an abnormal operation of an electrode assembly, sealing portions each having an electrode tab relatively insecurely sealed thereto are unsealed, thereby releasing the gas. In this case, the electrode assembly may undergo deformation until the sealing portions are unsealed. In addition, when the sealing portions each having an electrode tab are unsealed, the electrode tabs may be short-circuited to each other and there is a danger of fire. However, according to the present invention, the vent 130 may be formed in the pouch 120, thereby rapidly releasing the gas generated due to the abnormal operation of the electrode assembly 110. In addition, the vent 130 may be formed to be far from portions from which the electrode tabs 114 and 115 are drawn, thereby preventing short circuits between the electrode tabs 114 and 115 having different polarities and preventing the danger of fire.

Referring to FIG. 3, the vent 130 may be a trench formed in the metal layer 120b of the pouch 120. That is to say, the vent 130 may be a portion where a trench may be formed in the metal layer 120b to make the metal layer 120b of the pouch 120 shallower than its surrounding portion. Here, the vent 130 may be formed by placing the metal layer 120b in a mold frame, followed by pressing. That is to say, the pouch 120 may be formed by forming the vent 130 in the metal layer 120b and then forming the first pouch layer 120a and the second pouch layer 120c on both surfaces of the metal layer 120b. The vent 130 may be formed by forming a trench on a surface of the metal layer 120b contacting the first pouch layer 120a. Accordingly, the trench formed in the metal layer 120b may be filled with the first pouch layer 120a.

As described above, since the vent 130 may be formed by forming a trench in the metal layer 120b, it is a relatively weak portion of the pouch 120 in mechanical strength. Therefore, when the gas is generated in the pouch 120 and the pouch 120 swells due to the abnormal operation of the electrode assembly 110, the vent 130 is first ruptured, thereby rapidly releasing the gas in the pouch 120 to the outside.

Next, a rechargeable battery according to another embodiment of the present invention will be described.

FIG. 4 is a cross-sectional view of a rechargeable battery according to another embodiment of the present invention.

The rechargeable battery 200 according to another embodiment of the present invention is substantially the same as the rechargeable battery 100 according to the previous embodiment in view of configuration and function, except for the configuration of a vent 230. Accordingly, the following description of the rechargeable battery 200 will focus on the vent 230.

As shown in FIG. 2, the vent 130 may be formed at one corner of the pouch 120 and may be shaped of a diagonal line extending from the long side to the short side of the pouch 120. However, referring to FIG. 4, the vent 230 may be formed by forming a trench on a surface of the metal layer 120b of the pouch 120 contacting the second pouch layer 120c. Accordingly, the trench formed in a metal layer 120b may be filled with the second pouch layer 120c. In addition, since the vent 130 may be formed on a surface contacting the second pouch layer 120c, it can be discernible from the outside.

As described above, in the rechargeable battery 200 according to another embodiment of the present invention, the vent 230 may be formed at one side of the pouch 120, thereby rapidly releasing the gas generated due to an abnormal operation of the electrode assembly 110 to the outside.

Next, a rechargeable battery according to still another embodiment of the present invention will be described.

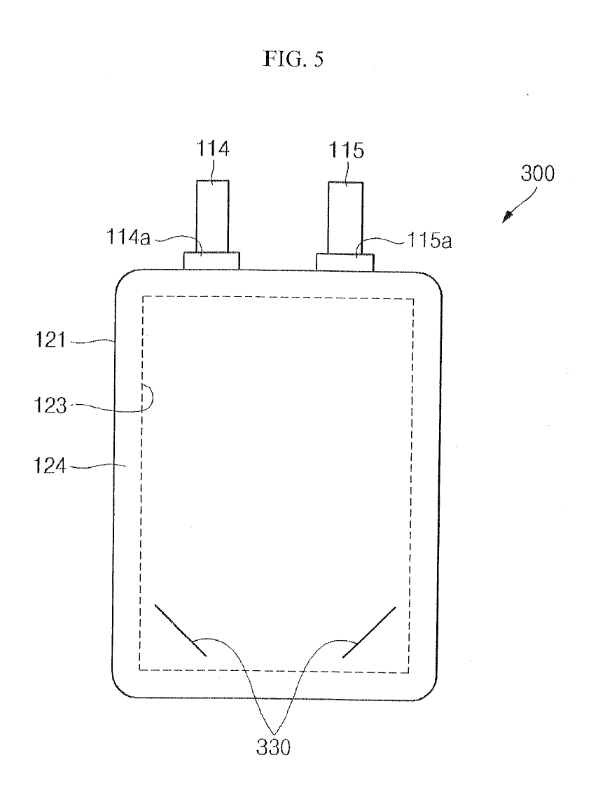

FIG. 5 is a front view of a rechargeable battery according to still another embodiment of the present invention.

The rechargeable battery 300 according to still another embodiment of the present invention is substantially the same as the rechargeable battery 100 shown in FIG. 2 in view of configuration and function, except for formation locations of vents 330. Accordingly, the following description of the rechargeable battery 300 will focus on the vents 330.

Referring to FIG. 5, the vents 330 are formed to be closer to the short side facing the short side from which first and second electrode tabs 114 and 115 are drawn. In other words, the vents 330 are formed to be far from the first and second electrode tabs 114 and 115. The vents 330 are symmetrically formed at both corners of a pouch 120 and are shaped of diagonal lines extending from long sides to short sides of the pouch 120. In addition, as shown in FIGS. 3 and 4, the vents 330 may be formed by forming trenches at upper or lower portions of a metal layer 120b. Therefore, when the gas is generated in the pouch 120 due to an abnormal operation of an electrode assembly 110 and the pouch 120 swells, the vents 330 formed at both corners of the pouch 120 are ruptured, thereby rapidly releasing the gas in the pouch 120 to the outside.

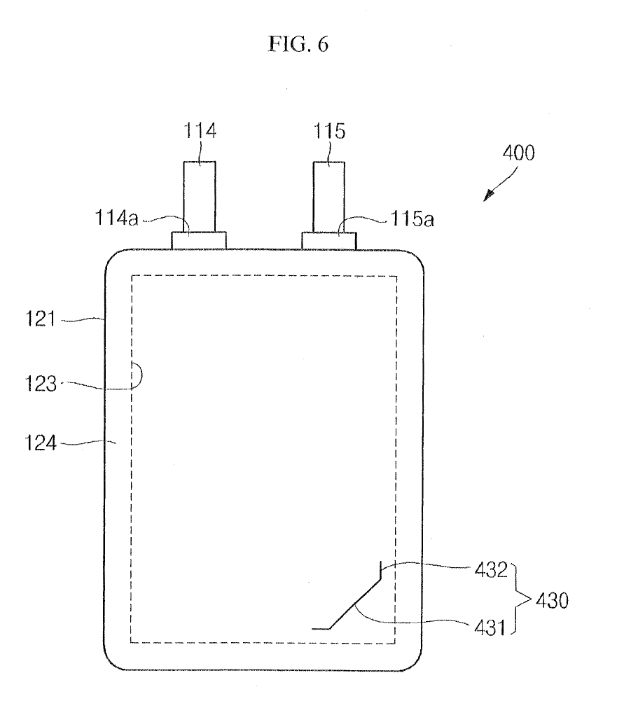

FIG. 6 is a front view of a rechargeable battery according to still another embodiment of the present invention.

The rechargeable battery 400 according to still another embodiment of the present invention is substantially the same as the rechargeable battery 100 shown in FIG. 2 in view of configuration and function, except for a formation location of a vent 430. Accordingly, the following description of the rechargeable battery 400 will focus on the vent 430.

Referring to FIG. 6, the vent 430 may be formed to be closer to the short side facing the short side from which first and second electrode tabs 114 and 115 are drawn. In other words, the vent 430 may be formed to be far from the first and second electrode tabs 114 and 115. The vent 430 may be formed at one corner of a pouch 120 and may be shaped of a diagonal line extending from the long side to the short side of the pouch 120. The vent 430 includes a main vent portion 431 and auxiliary vent portions 432. The main vent portion 431 may be shaped of a diagonal line extending from the long side to the short side of the pouch 120. The auxiliary vent portions 432 extend from opposite ends of the main vent portion 431 to be parallel with the long side and short side of the pouch 120. When the gas is generated in the pouch 120 and the pouch 120 swells due to an abnormal operation of an electrode assembly 110, the auxiliary vent portions 432 assists the main vent portion 431 in being easily ruptured. In addition, as shown in FIGS. 3 and 4, the vent 430 may be formed by forming a trench at an upper or lower portion of the metal layer 120b.

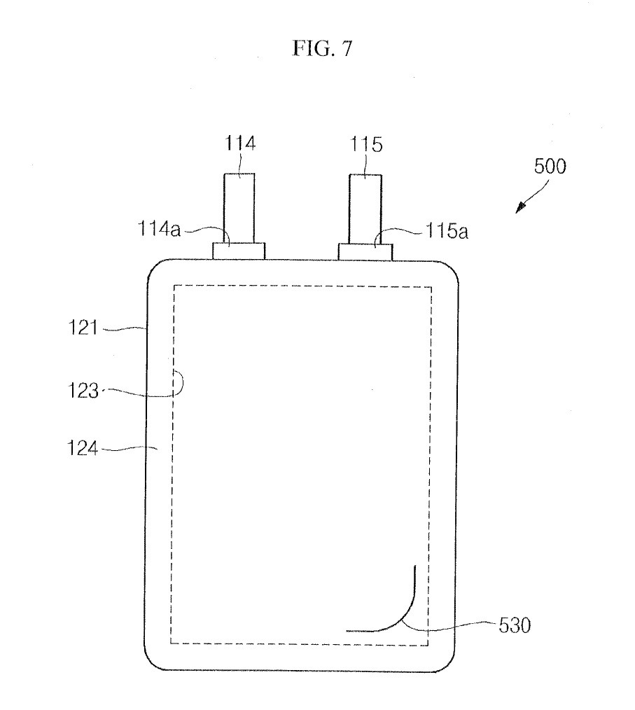

FIG. 7 is a front view of a rechargeable battery according to still another embodiment of the present invention.

The rechargeable battery 500 according to still another embodiment of the present invention is substantially the same as the rechargeable battery 100 shown in FIG. 2 in view of configuration and function, except for a formation location of a vent 530. Accordingly, the following description of the rechargeable battery 500 will focus on the vent 530.

Referring to FIG. 7, the vent 530 may be formed to be closer to the short side facing the short side from which first and second electrode tabs 114 and 115 are drawn. In other words, the vent 530 may be formed to be far from the first and second electrode tabs 114 and 115. The vent 530 may be formed at one corner of a pouch 120 and may be shaped of an arc extending from the long side to the short side of the pouch 120. In addition, as shown in FIGS. 3 and 4, the vent 530 may be formed by forming a trench at an upper or lower portion of a metal layer 120b.

Therefore, when the gas is generated in the pouch 120 and the pouch 120 swells due to an abnormal operation of an electrode assembly 110, the vent 530 may be ruptured, thereby rapidly releasing the gas in the pouch 120 to the outside.

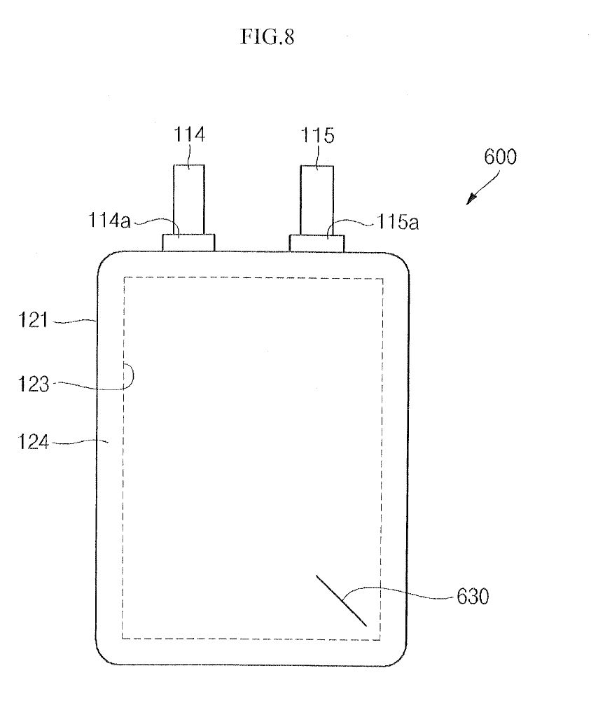

FIG. 8 is a front view of a rechargeable battery according to still another embodiment of the present invention.

The rechargeable battery 600 according to still another embodiment of the present invention is substantially the same as the rechargeable battery 100 shown in FIG. 2 in view of configuration and function, except for a formation location of a vent 630. Accordingly, the following description of the rechargeable battery 600 will focus on the vent 630.

Referring to FIG. 8, the vent 630 may be formed to be closer to the short side facing the short side from which first and second electrode tabs 114 and 115 are drawn. In other words, the vent 630 may be formed to be far from the first and second electrode tabs 114 and 115. The vent 630 may be formed at one corner of a pouch 120 and may be shaped of a diagonal line extending toward an interconnection point where the long side and the short side of the pouch 120 meet. That is to say, since the central part of the pouch 120 is first expanded when the pouch 120 swells, the vent 630 is easily ruptured according to the swelling of the pouch 120. In addition, as shown in FIGS. 3 and 4, the vent 630 may be formed by forming a trench at an upper or lower portion of a metal layer 120b.

Therefore, when the gas is generated in the pouch 120 and the pouch 120 swells due to an abnormal operation of an electrode assembly 110, the vent 630 may be ruptured, thereby rapidly releasing the gas in the pouch 120 to the outside.

While this invention has been described in connection with what is presently considered to be practical exemplary embodiments, it is to be understood that the invention is not limited to the disclosed embodiments, but, rather is intended to cover various modifications and equivalent arrangements included within the spirit and scope of the appended claims.

What is claimed is:

1. A rechargeable battery, comprising:
an electrode assembly including a first electrode, a second electrode and a separator interposed between the first electrode and the second electrode;
a pouch accommodating the electrode assembly and including a metal layer; and
a vent formed on at least one side of the pouch,
wherein the vent is formed by forming a trench in the metal layer.

2. The rechargeable battery of claim 1, wherein the pouch further includes a first pouch layer formed on one surface of the metal layer facing the electrode assembly, and a second pouch layer formed on the other surface of the metal layer.

3. The rechargeable battery of claim 2, wherein the vent is formed by forming a trench on one surface of the metal layer contacting the first pouch layer.

4. The rechargeable battery of claim 2, wherein the vent is formed by forming a trench on the other surface of the metal layer contacting the second pouch layer.

5. The rechargeable battery of claim 2, wherein the first pouch layer is made of an insulating, thermally adhesive material.

6. The rechargeable battery of claim 2, wherein the second pouch layer is made of at least one of nylon, polyethylene terephthalate (PET), polybutylene terephthalate (PBT) and polybutylene naphthalate (PBN).

7. The rechargeable battery of claim 1, further comprising electrode tabs electrically connected to the first electrode and the second electrode and protruding to the other side of the pouch, wherein the pouch has a pair of facing long sides and a pair of facing short sides connecting the long sides, the electrode tabs protrude one of the short sides, and the vent is formed to be close to the short side facing the short side from which the electrode tabs protrude.

8. The rechargeable battery of claim 1, wherein the vent is shaped of a diagonal line extending from the long side to the short side of the pouch.

9. The rechargeable battery of claim 1, wherein the vent is shaped of an arc extending from the long side to the short side of the pouch.

10. The rechargeable battery of claim 1, wherein the vent is shaped of a diagonal line extending toward an interconnection point where the long side and the short side of the pouch meet.

11. The rechargeable battery of claim 1, wherein the vent comprises:
a main vent portion shaped of a diagonal line extending from the long side to the short side of the pouch; and
auxiliary vent portions extending from opposite ends of the main vent portion and formed to be parallel with the long and short sides of the pouch.

12. The rechargeable battery of claim 1, wherein the vent is formed at one corner of the pouch.

13. The rechargeable battery of claim 1, wherein the vent is formed at both corners of the pouch.

14. The rechargeable battery of claim 1, wherein the pouch includes a first pouch film having an accommodation groove in which the electrode assembly is accommodated, and a second pouch film covering the accommodation groove and coupled to the first pouch film, and the vent is formed in the accommodation groove of the first pouch film.

15. The rechargeable battery of claim 14, wherein the pouch has a pair of facing long sides and a pair of facing short sides connecting the long sides, the first pouch film and the second pouch film are connected to each other through one of the pair of short sides, and the vent is formed to be close to the one short side.

16. The rechargeable battery of claim 14, wherein a sealing portion is formed on the outer periphery of the accommodation groove of the first pouch film to be sealed to the second pouch film.

17. The rechargeable battery of claim 15, further comprising electrode tabs electrically connected to the first electrode and the second electrode and protruding to one side of the pouch, wherein each of the electrode tabs includes an insulation member formed at contact portions between the electrode tabs and the sealing portion.

18. A rechargeable battery pouch containing an electrode assembly having a first electrode, a second electrode and a separator interposed between the first electrode and the second electrode, said pouch comprising:
a metal layer;
a first pouch layer directly attached to one side of the metal layer;
a second pouch layer directly attached to another side of the metal layer opposite to that of the first pouch layer; and
a vent formed solely on the metal layer, said vent being a trench in the metal layer entirely filled by the first pouch layer or the second pouch layer.

19. The battery pouch of claim 18, wherein said first pouch layer is made of an insulating, thermally adhesive material or casted polypropylene (CPP).

20. The battery pouch of claim 19, wherein said second pouch layer is made at least one of nylon, polyethylene terephthalate (PET), polybutylene terephthalate (PBT) and polybutylene naphthalate (PBN).
